(19) United States
(12) Patent Application Publication
(10) Pub. No.: US 2011/0317830 A1
(43) Pub. Date: Dec. 29, 2011

(54) SELECTIVE STORAGE OF DATA REPRESENTATIVE OF DECRYPTED VIDEO CONTENT

(75) Inventor: Jon Todd Richardson, Chamblee, GA (US)

(73) Assignee: ECHOSTAR DATA NETWORKS CORPORATION, Englewood, CO (US)

(21) Appl. No.: 12/822,915

(22) Filed: Jun. 24, 2010

(51) Int. Cl. H04N 7/167

(52) U.S. Cl. 380/201

(57) ABSTRACT

A method of processing video content is provided. In the method, a stream of encrypted video content is received. The encrypted video content stream is decrypted. Storage of an entirety of the decrypted video content for an indefinite period of time is prohibited under a license required to decrypt the encrypted video content. The stream of decrypted video content is processed to generate data representative of at least one aspect of the decrypted video content, wherein storage of the representative data does not violate the license. The representative data is then stored for at least one use other than viewing the entirety of the decrypted video content.

### BACKGROUND

Most new media content, such as audio and/or video content, produced today is either recorded digitally or converted to some digital format. Digital recording and storage formats generally allow the producer or authorized distributor of the content to generate an indefinite number of copies without any degradation in the quality of the content. However, this same technology allows content “pirates” and other entities to duplicate and distribute any number of unauthorized copies of an item of media content, thus reducing the potential amount of revenue to be gained by the originator of the content.

To help prevent unauthorized access to such content, various digital copy protection schemes have been proposed and implemented. For example, to prevent the unauthorized capture of content between a content source device (such as a television receiver set-top box) and a content output device (such as a television), Intel® Corporation developed High-bandwidth Digital Content Protection (HDCP), which is a specific form of digital copy protection designed to prevent the copying of digital audio and video content as it is transported across a digital interface, such as High-Definition Multimedia Interface (HDMI) and Digital Visual Interface (DVI). Users of the technology must obtain a license to employ the technology. To comply with the license, encrypted content that has been decrypted in a display device may only be stored for no longer than what is required to perform a desired display or presentation operation. (See Section 3.2, “Temporary Buffering”, of Exhibit C, “Compliance Rules”, of the HDCP License Agreement, revised Feb. 24, 2010.)

While display devices typically do not possess a need to store decrypted content for longer than what is required to present the content to a user or viewer, other worthwhile devices, such as video testing or troubleshooting devices, may present a challenge. To perform some diagnostic functions, some testing devices may be designed to decrypt and store video data transmitted by a content source device for later processing and analysis. While the functions of such a device may not present a problem in and of themselves for digital content providers, the potential for a content pirate to employ such a device to copy digital content may be a cause of concern on the part of the providers.

### BRIEF DESCRIPTION OF THE DRAWINGS

Many aspects of the present disclosure may be better understood with reference to the following drawings. The components in the drawings are not necessarily depicted to scale, as emphasis is instead placed upon clear illustration of the principles of the disclosure. Moreover, in the drawings, like reference numerals designate corresponding parts throughout the several views. Also, while several embodiments are described in connection with these drawings, the disclosure is not limited to the embodiments disclosed herein. On the contrary, the intent is to cover all alternatives, modifications, and equivalents.

FIG. 1A is a simplified block diagram of a video presentation system from the prior art that employs video encryption and decryption.

FIG. 1B is a simplified block diagram of a video capture system that receives and processes encrypted video data according to an embodiment of the invention.

FIG. 2 is a flow diagram of a method according to an embodiment of the invention of processing video content.

FIG. 3 is a block diagram of a video capture/analysis device according to an embodiment of the invention.

FIG. 4 is a graphical representation of a decrypted video stream according to an embodiment of the invention.

FIG. 5 is a graphical representation of a decrypted video frame as the frame may be presented on a video display.

### DETAILED DESCRIPTION

The enclosed drawings and the following description depict specific embodiments of the invention to teach those skilled in the art how to make and use the best mode of the invention. For the purpose of teaching inventive principles, some conventional aspects have been simplified or omitted. Those skilled in the art will appreciate variations of these embodiments that fall within the scope of the invention. Those skilled in the art will also appreciate that the features described below can be combined in various ways to form multiple embodiments of the invention. As a result, the invention is not limited to the specific embodiments described below, but only by the claims and their equivalents.

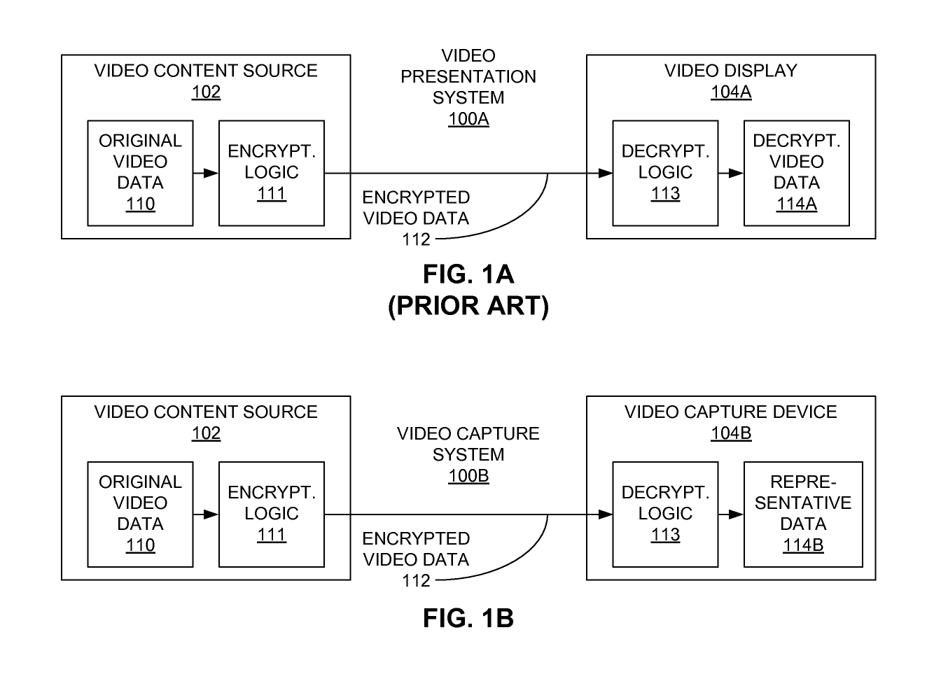

FIG. 1A is a simplified block diagram of a video presentation system 100A from the prior art. The system 100A includes a video content source 102 communicatively coupled with a video display 104A. The video content source 102 may be any electronic device receiving or otherwise accessing original video data 110, encrypting the original video data 110 according to a digital copy protection scheme via encrypting logic 111, and then transmitting or transferring the resulting encrypted video data 112 to the video display 104A or other video presentation device. Many types of video content sources 102 are possible, including, but not limited to, satellite, cable, and terrestrial (“over-the-air”) television receivers or set-top boxes, digital video recorder (DVR) units, Digital Video Disc (DVD) players, and gaming consoles. The video content source 102 may transfer the encrypted video data 112 over a wired or wireless digital data interface, such as HDMI or DVI.

The video display 104A, such as a television or video monitor, receives the encrypted video data 112, and decrypts the data 112 via decryption logic 113 to yield decrypted video data 114A for display to a viewer. Typically, the decrypted video data 114A is a duplicate of the original video data 110 resident within, or accessible via, the video content source 102, due to the complementary nature of the encryption and decryption operations.

As mentioned above, the encryption and decryption operations help prevent unauthorized access and storage of original video data 110 by transmitting only the encrypted video data 112 from the content source 102 to the display 104A. Oftentimes, use of a copy protection scheme such as HDCP that employs the encryption/decryption operations is covered by a license agreement that also requires the video display 110A to only buffer the decrypted video data 114A for as long as is necessary to present the video to a viewer. Such a requirement reduces the odds that a clever pirate will be able to access and copy the decrypted video data 114A from within the display 104A, thus further enhancing the security of the copy protection scheme.

Aside from video displays 104A, other worthwhile devices may be configured to receive and decrypt the encrypted video data 112 transmitted from the video content source 102. For example, as shown in FIG. 1B, a video capture system 100B may include the video content source 102 of FIG. 1A, along with a video capture device 104B. In this case, the video capture device 104B receives and decrypts the encrypted video data 112. While not intended to display the resulting decrypted video data to a user, the video capture device 104B is configured to analyze the decrypted video data to discover defects or anomalies in the data in order to test or troubleshoot the internal circuitry of the video content source 102. To that end, the video capture device 104B stores data 114B representative of at least one characteristic or aspect of the decrypted video data that may be analyzed to determine whether the decrypted video data contains defects. Depending on the embodiment, the representative data 114B may include statistical data, information identifying portions of the decrypted video data, or portions of the decrypted video data. By not storing the entirety of the decrypted video data indefinitely, the video capture device 104B should not be in violation of a license covering the user of the decryption logic 113 that restricts the indefinite storing of the decrypted video data.

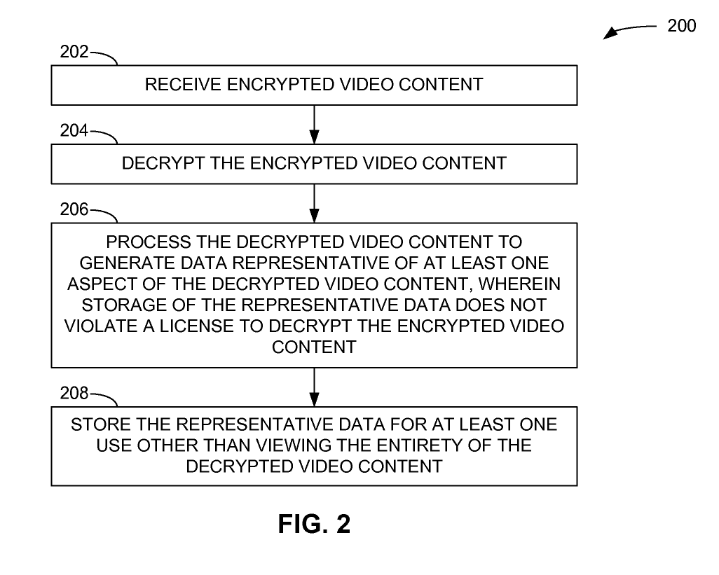

FIG. 2 provides a flow diagram of a method 200 of processing video data according to an embodiment of the invention. The method 200 may be performed by the video capture system 104B of FIG. 1B, or by another device that functions to extract information regarding decrypted video data for any legitimate purpose. In the method 200, encrypted video content is received (operation 202). The encrypted video content is then decrypted (operation 204). A license required to decrypt the encrypted video content prohibits storing the entirety of the decrypted video content for an indefinite time period. In some cases, the license may be more restrictive by prohibiting the storing of significantly less than the entirety of the decrypted video content. The decrypted video content is processed to generate data representative of at least one aspect of the decrypted video content, wherein storage of the representative data does not violate the license (operation 206). The representative data is then stored for at least one use other than viewing the entirety of the decrypted video content (operation 208), such as for analysis to determine the status of the decrypted video data.

In other embodiments, a computer-readable storage medium, such as a computer memory component or storage device, may have encoded thereon instructions for a processor or other control circuitry of the video capture device 104B or another electronic device capable of receiving and decrypting encrypted video data to implement the method 200.

As a result of employing the method 200, violation of a license agreement covering the use of the decryption logic necessary to decrypt the encrypted video data may be avoided while allowing access to the video data in non-presentation environments. Access to such data may be helpful in the testing and fault diagnosis of encryption logic 111 or other portion of the video content source 102 hardware or software illustrated in FIG. 1. Additional advantages may be recognized from the various implementations of the invention discussed in greater detail below.

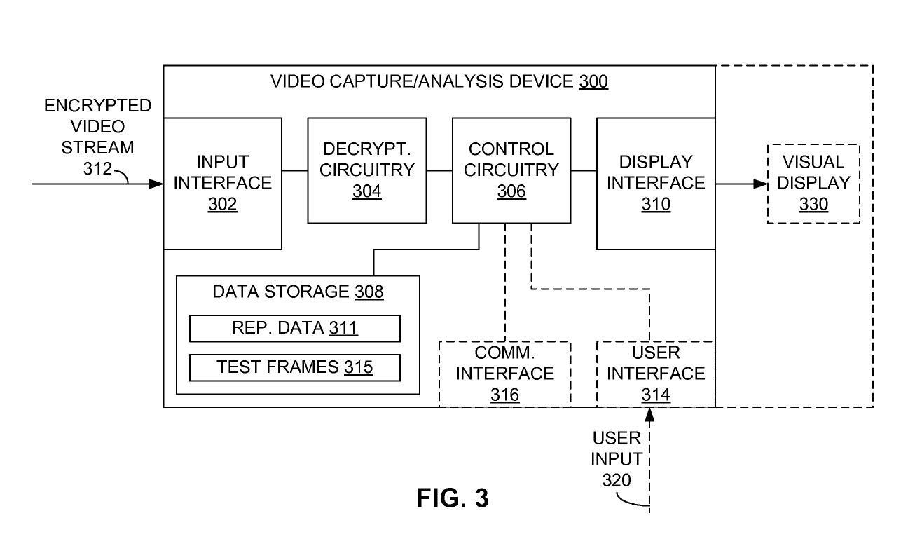

FIG. 3 presents a block diagram of a video capture/analysis device 300 according to another embodiment of the invention. In one implementation, the video capture/analysis device 300 is configured to test, analyze, and/or troubleshoot an encrypted video stream 312 generated by another device, such as a satellite, cable, or terrestrial television receiver or set-top box, a DVD player, a standalone digital video recorder (DVR) unit, a gaming system, or other electronic device capable of encrypting video content for transmission to another device. As depicted in FIG. 3, the video capture/analysis device 300 includes an input interface 302, decryption circuitry 304, data storage 308, a display interface 310, and control circuitry 306. The device 300 may also include a visual display 330, a user interface 314, and/or a communication interface 316 in some embodiments. Other components, such as a power supply, may be included in the device 300, but are not discussed further hereinafter to focus and simplify the following discussion.

The input interface 302 is configured to receive the encrypted video stream 312 and process the stream 312 for use via the decryption circuitry 304. In one example, the input interface 302 incorporates High-Definition Multimedia Interface (HDMI) circuitry for receiving the video stream 312 over an HDMI connection, such as one that may be employed to transfer the data from a set-top box or other video content source device to a television or other display device configured to decrypt the encrypted video stream 312 and display the content to a user. Other types of video interface connections, such as a component video connection, a composite video connection, a modulated radio frequency (RF) video connection, or other video connection capable of carrying the encrypted video stream 312, may be utilized in other implementations of the device 300.

Generally, the video stream 312 is encrypted to prevent unauthorized access to, as well as storage and subsequent copying of, the video content in the stream 312, as described above. According to one implementation, the video content is encrypted according to the High-bandwidth Digital Content Protection (HDCP) system mentioned above, which enjoys widespread use in the consumer video content market. However, copy protection schemes other than HDCP may be used to generate the encrypted video stream 312 in other embodiments. In addition, the underlying video content may be structured according to any video content format that is compatible with the copy protection scheme being utilized.

After receiving the encrypted video stream 312 via the input interface 302, the decryption circuitry 304 is configured to decrypt the video stream 312. Under normal circumstances, an authorized device, such as a television or video monitor, that receives the encrypted video stream 312 decrypts the stream 312 and subsequently processes the resulting decrypted content for presentation to a user. To protect the video content in the decrypted state, use of the decrypted video data may be restricted by a license governing the use of the copy protection scheme. One such restriction may be that any decrypted video data not be stored in the receiving device for an indefinite period of time. For example, the license may require that any decrypted video content be stored only long enough to allow display of the content to the user, after which the decrypted content is to be deleted or overwritten with newer decrypted video content being stored for display purposes. Processing the decrypted video content in such a manner presumably reduces the possibility that the decrypted data may be copied from the memory of the receiving device by an unauthorized or unlicensed party and distributed at will.

However, some worthwhile special-purpose devices, such as the video capture/analysis device 300 of FIG. 3, may require storage of at least some data representative of the decrypted video content for later retrieval and analysis, such as by a human technician, for some indefinite period of time. To comply with the license, the representative data may be of a form or substance that is useful for analysis purposes while not being suitable for general viewing of the content. As is described in greater detail below, the representative data may include, for example, portions of the decrypted video content itself, or data representing various aspects or characteristics of the decrypted video content. To that end, the control circuitry 306 of the video device 300 receives the decrypted video data from the decryption circuitry 304 and processes the decrypted data to generate representative data that, if stored for some period of time, will not violate the license covering the use of the data protection scheme.

Generally, the control circuitry 306 is configured to control and/or access other components of the video content device 300, including, but not limited to, the input interface 302, the decryption circuitry 304, the data storage 308, the display interface 310, and, if included, the visual display 330, the user interface 314, and/or the communication interface 316. The functionality of the control circuitry 306 as it more specifically relates to the generation of the representative data is described more completely below. The control circuitry 306 may include one or more processors, such as a microprocessor, microcontroller, or digital signal processor (DSP), configured to execute instructions directing the processor to perform the functions associated with the control circuitry 306. In another implementation, the control circuitry 306 may be completely hardware-based logic, or may include a combination of hardware, firmware, and/or software elements.

After generating the data representative of the decrypted video content, the control circuitry 306 is configured to store the representative data in the data storage 308 as representative data 311. The control circuitry 306 may further process the representative data 311 after being placed in the data storage 308 for any analysis or troubleshooting purposes. The data storage 308 may include any type of volatile or nonvolatile memory capable of storing video content, including, but not limited to, static random access memory (SRAM), dynamic random access memory (DRAM), flash memory, and magnetic and/or optical disk drives.

The control circuitry 306 may further retrieve at least a portion of the representative data 315 from the data storage 308 and transfer the representative data 311 in visible form, such as numerical characters, graphs, diagrams, and the like, to the display interface 310 for ultimate presentation to the user by way of the visual display 330. As shown in FIG. 3, the display 330 may be incorporated within the video capture/analysis device 300, or may reside external thereto. In one implementation in which the visual display 330 is external to the device 300, the display interface 310 may be any interface adapted to generate video signals for a television device, such as a composite or component video connection, a modulated radio frequency (RF) connection, a High-Definition Multimedia Interface (HDMI) connection, or any other format compatible with the visual display 330.

To allow a user to control the operation of the device 300, the user interface 314 may be configured to receive user input 320 allowing the user to specify the type, format, and/or amount of the representative data 311, as well as any other information that the control circuitry 306 may employ to control the generation and display of the representative data 311. The user input 320 may also control other operational aspects of the device 300 not specifically described herein. In many examples, the user interface 314 may be a remote control interface configured to receive such input 320 by way of infrared (IR), radio frequency (RF), acoustic, or other wireless signals produced by a remote control device. To facilitate such command entry, the video content device 300 may provide a menu system presented to the user via the visual display 330. In some implementations, the user interface 314 may also include any of a keyboard, mouse, and/or other user input device.

In some arrangements, the video capture/analysis device 300 may include a communication interface 316 configured to receive input from, and transfer the representative data 311 to, a separate electronic device over a communication link. The communication interface 316 may be configured to communicate via any communication protocol, including but not limited to Universal Serial Bus (USB) interface, an Ethernet interface, an IEEE 802.11x (Wi-Fi) interface, an IEEE 1394 interface, a Bluetooth® interface, a HomePlug® interface, and a cellular telephone network

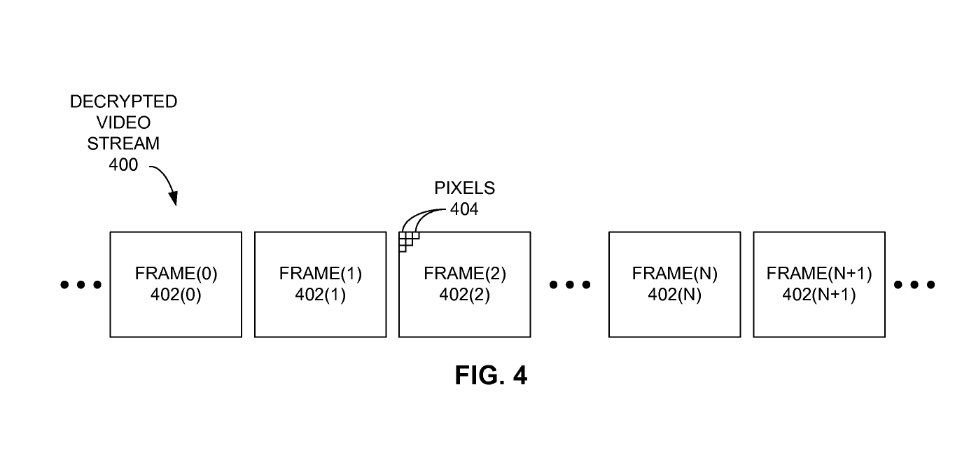

In one example, the decryption circuitry 304 decrypts the encrypted video stream 312 received by way of the input interface 302 to yield a decrypted video stream 400, as illustrated in FIG. 4. In this case, the decrypted video stream 400 is composed of a sequence of multiple still images or “frames” 402(0), 402(1), . . . , with each frame 402 intended to be displayed to a user for some limited period of time, and with the successive presentation of the frames 402 creating a moving image from the perspective of the user. Further, each frame 402 is formed by multiple picture elements (“pixels”) 404 arranged in an array of multiple columns and rows, with each pixel 404 describing a particular color (chrominance) and brightness or intensity (luminance) for its particular portion of the frame 402. While FIG. 4 describes a type of uncompressed video format, in which each frame 402 and pixel 404 is explicitly specified, the decrypted video stream 400 may also be a compressed video format, such as the formats defined by the Motion Picture Experts Group, including MPEG-2 and MPEG-4. Any other type of compressed or uncompressed video format may be employed as the decrypted video stream 400 in other embodiments.

In some implementations, the control circuitry 306 processes the decrypted video stream 400 to generate some reduced, redacted, or altered version of the decrypted video stream 400 that is useful from an analysis standpoint, but less so from a viewing enjoyment perspective. For example, the control circuitry 306 may generate a lower-resolution version of each frame 402 of the decrypted video stream 400 as the representative data 311 for storing in the data storage 308 for subsequent analysis. In one implementation, the lower-resolution version may represent something less than a high-definition or standard-definition version of the decrypted video stream 400.

In other examples, the control circuitry 306 may select a subset of the frames 402 of the decrypted video stream 400. In one implementation, the control circuitry 306 may select every Nth frame 402 for storing as the representative data 311. Presumably, the value for N should be low enough to allow meaningful analysis of the decrypted video stream 400, and yet be sufficiently high to allow such storage for an indefinite period of time while adhering to the restrictions of the license. Further, the value for N may be related to the presentation rate of the frames 402 of the decrypted video stream 400. For example, for a 60 Hertz (Hz) presentation rate (i.e., the decrypted video stream 400 is normally presented at a rate of 60 frames 402 per second), a value of 30 for N would result in two frames 402 per second being stored in the data storage 308, resulting in only 1/30th of the total information in the decrypted video stream 400 being stored for some period of time. More generally, any value of N greater than one may suffice under the license restrictions associated with the copy protection scheme. In other schemes, the control circuitry 306 may select groups of multiple frames 402 appearing every N frames 402 in the decrypted video stream 400 as the representative data 311. In an alternative embodiment, the control circuitry 306 may select one frame at each of predetermined points of presentation time in the decrypted video stream 400. For example, the control circuitry 306 may select one or more frames 402 every tenth of a second of presentation time from the decrypted video stream 400 for storing as the representative data 311 in the data storage 308. Other presentation time spans for selecting one or more frames 402 may be employed in other implementations.

As opposed to pre-selecting the frames 402 to be stored, as described above, the control circuitry 306 may analyze one or more characteristics or aspects of each frame 402, and store any frames 402 whose analyzed characteristics that attain some predetermined level (and possibly a number of subsequent frames 402) in the data storage 308. For example, the pixels 404 of each frame 402 may be analyzed to determine an average luminance or chrominance level for the frame 402. If the average luminance or chrominance channel level exceeds some predetermined threshold, the frame 402 being analyzed may be stored in the data storage 308, possibly along with a predetermined number of subsequent or preceding frames 402. In other examples, if any individual pixels 404 of a frame 402 attain some level of luminance or chrominance, the associated frame 402 may be stored as the representative data 311. Further, changes in average luminance or chrominance level between subsequent frames 402 may serve as a trigger to store one or more frames 402 in the data storage 308. In another example, the number of pixels 404 that are higher or lower in luminance or chrominance level compared to some threshold value may determine whether storage of the associated frame 402 is triggered. As a result, the control circuitry 306 may be able to store frames 402 that exhibit some type of luminance or chrominance anomaly, such as noise spikes, flashes, improper colors, and the like.

In other embodiments, the control circuitry 306 may compare corresponding pixels 404 of adjacent frames 402, or adjacent pixels 404 of the same frame 402, to each other in terms of luminance, chrominance, or another statistical value to determine whether the associated frame 402 is to be stored in the data storage 308. Triggering storage of frames 402 in this manner may help discover pixel-related problems, such as “sparkles”, which may be outlier pixels 404 that are radically different in terms of color or brightness with respect to surrounding pixels 404 or the corresponding pixel 404 of a previous or subsequent frame 402.

In some cases, data other than the video data in each of the frames 402 of the decrypted video stream 400 may be employed to trigger the storage of the representative data 311 generated from the decrypted video stream 400. More specifically, the decrypted video stream 400 may include, or be transmitted along with, auxiliary data, control data, or “metadata”. Examples of metadata include, but are not limited to, “infoframes” and packets provided in HDMI, Consumer Electronics Control (CEC) commands (utilized for entertainment device control over HDMI), I²C/DDC (Inter-Integrated Circuit/Display Data Control) data (generally employed for computer monitors and displays for HDCP and EDID (Extended Display Identification Data)) protocols, and even data transmitted during the vertical blanking interval (VBI) in analog video transmissions. For example, a particular HDCP data or key exchange over HDMI may be employed as a trigger to generate representative data 311 from one or more frames 402 received after the HDCP-related trigger. The use of such triggers may help in cases when anomalies in the decrypted video stream 400 appear to be related to certain types or values of metadata.

In another example, changes in the cadence of the frames 402 as presented in the decrypted video stream 400 may be detected by comparing adjacent frames 402 of the stream 400 to check for identical frames. Typically, adjacent identical frames 402 may exist in the stream 400 under some circumstances, such as when a film operating at 24 frames per second has been transferred to video at approximately 30 frames per second to ensure that the video content is presented at the same overall rate as what was provided in the original film. This process is often termed “three-two pulldown”. By checking the cadence of the frames 402 in such a manner, mistakes in the film-to-video conversion process, or in subsequent processing of the resulting video content, may be detected and analyzed.

As opposed to comparing one or more statistical criteria, such as average luminance or chrominance levels of consecutive frames 402, adjacent or corresponding pixels 404, or the like, the control circuitry 306 may instead compare each frame 402 with one or more test frames 315 previously stored in the data storage 308 of the device 300. The control circuitry 306 may then store each frame 402 of the decrypted video stream 400 that does not exactly match one of the test frames 315, possibly along with some number of preceding or subsequent frames 402. In other examples, the control circuitry 306 may store only those frames 402 which vary from the test frames 315 by some statistical amount, such as when the number of corresponding pixels 404 of the analyzed frame 402 and the test frames 315 that are different exceeds some number or percentage. Luminance and chrominance levels of individual pixels 404, and average luminance and chrominance levels of the decrypted frames 402, when compared to the test frames 315, may also be used as triggers for storing the frames 402 as the representative data 311.

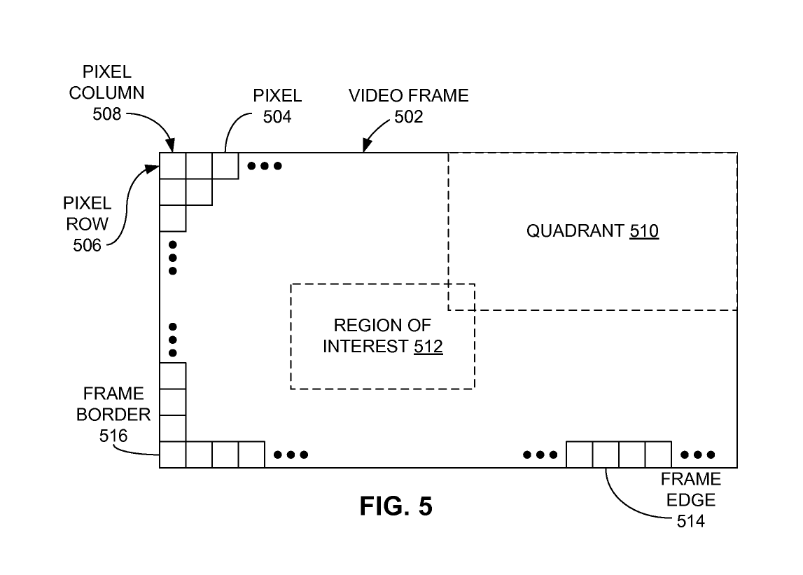

In another embodiment, the control circuitry 306 may select a portion of each frame 402 that is less than the entirety of each frame 402 to be stored as the representative data 311 in the data storage 308. FIG. 5 provides a graphical representation of a video frame 502 and some portions thereof that may be stored for analysis purposes. For example, the control circuitry 306 may select portions such as a quadrant 510 or some other definable region of interest 512 of each frame 402 for storage. Smaller areas, such as individual pixels 504, pixel rows 506, and pixel columns 508, may serve as selected portions of the frame 502 for storage. More particularly, an entire frame edge 514 or frame border 516 or one or more pixels 504 in thickness may be stored in a similar manner. In other implementations, the capture triggers mentioned above, such as average luminance or chrominance levels, may be applied specifically to a selected region within each frame 502 for triggering purposes. For each frame 402 region that is selected according to the triggers in use, the control circuitry 306 may store either the selected region of that frame 402, or the totality of that frame 402, as the representative data 311.

When the control circuitry 306 selects and stores one or more frames 402, or portions thereof, as the representative data 311, the control circuitry 306 may also store information identifying each of the frames 402, and/or information indicating a reason as to why the frame 402 was stored. The identifying information may be a frame number, a timestamp, or some other data uniquely identified with the frame 402. The information indicating the reason for storage may include, for example, a characteristic, such as an average luminance or chrominance value, associated with the frame 402 that caused the control circuitry 306 to select the frame 402 for storage. Such information may be especially valuable in cases in which multiple trigger values are employed, and in which the identity of the particular trigger that was responsible for the storing of the frame 402 may be unclear.

In yet another embodiment, the one or more statistical characteristics causing the triggering may be stored as the representative data 311 for the frame 402 in lieu of the frame 402, or portion thereof. Such information may be all that is necessary for conducting an analysis of the decrypted video stream 400. Examples of the statistical data that may be stored includes, but is not limited to, average chrominance or luminance values for the pixels 404 of a frame 402, a histogram of the pixel luminance and chrominance values of the frame 402, and a range of the pixel chrominance or luminance values of the frame 402. In another example, the control circuitry 306 may store at least one of a timestamp and a frame number as identification information for the selected frame 402. In that case, the periodic occurrence of an error, such as one that affects every X number of frames 402, may be easier for a user to detect if the timestamps or frame numbers are used to identify the frames 402 selected. The control circuitry 306 may also store both the statistical characteristics and the identification information in some implementations.

To select the one or more particular statistical criteria employed as triggers for frame 402 capture, to specify the region of each frame 402 to be captured or analyzed for triggering purposes, to directly identify the frames 402 to be captured, and/or to set other operational parameters discussed above by which the control circuitry 306 is to operate, the user may enter such information as user input 320 via the user interface 314. Depending on the nature of the license restrictions covering the use of the decryption circuitry 304 of the video capture/analysis device 300, the control circuitry 306 may prevent the capture and storage of various frames 402 of the decrypted video stream 400 if the operational parameters as defined by the user would result in an amount of the video stream 400 being captured that would violate the terms of the license. Further, the control circuitry 306 may inform the user, such as by way of the visual display 330, that one or more of the operational parameters must be changed to allow capture of representative data 311 that conforms to the terms of the license. Additionally, the control circuitry 306 may suggest changes to the selected operational parameters that would allow the subsequent capturing and storage of the representative data 311 to occur. Such an implementation would facilitate a wide range of operational possibilities for capturing the representative data 311 while enforcing the provisions of the license. The control circuitry 306 logic or firmware enforcing the license restrictions may also be updated, such as by way of the communication interface 316, if the restrictions are altered from time to time.

At least some embodiments as described herein thus facilitate the capture and storage of decrypted video data as regulated under a license for the video decryption technology for subsequent processing and/or analysis. By storing only portions of a decrypted video stream, or storing statistical data and other information related to the video stream in lieu of storing the entirety of the actual video data, any restrictions regarding storage of the decrypted video data to prevent unauthorized copying and playback may be obeyed while still allowing enough data to be captured for analysis and troubleshooting purposes.

Further, by storing only some subset of the decrypted video data or associated statistical information, the data storage employed may be capable of storing data associated with a greater number of decrypted video frames due to the reduced amount of information being stored for each frame. Such an advantage may be important in environments in which only a limited amount of data storage or buffer space is available. Accordingly, generating and storing such information may be desirable in situations in which the use of the decryption technology is not governed by a license or limited by any restrictions on the use or storage of the decrypted video data.

While several embodiments of the invention have been discussed herein, other implementations encompassed by the scope of the invention are possible. For example, while various embodiments have been described largely within the context of HDMI and the HDCP copy protection scheme, the use of other video content interfaces (both analog and digital in nature) and copy protections schemes not specifically discussed herein (including but not limited to Digital Transmission Content Protection (DTCP), Copy Generation Management System (CGMS), and Advanced Access Content System (AACS)) may also benefit from the concepts and teachings presented above. In addition, aspects of one embodiment disclosed herein may be combined with those of alternative embodiments to create further implementations of the present invention. Therefore, while the present invention has been described in the context of specific embodiments, such descriptions are provided for illustration and not limitation. Accordingly, the proper scope of the present invention is delimited only by the following claims and their equivalents.

What is claimed is:

1. A method of processing video content, the method comprising:
receiving a stream of encrypted video content;
decrypting the stream of encrypted video content, wherein storage of an entirety of the stream of decrypted video content for an indefinite period of time is prohibited under a license required to decrypt the encrypted video content;
processing the stream of decrypted video content to generate data representative of at least one aspect of the decrypted video content, wherein storage of the representative data does not violate the license; and
storing the representative data for at least one use other than viewing the entirety of the decrypted video content.

2. The method of claim 1, wherein:
processing the stream of decrypted video content comprises generating a lower-resolution version of the stream of decrypted video content; and
storing the representative data comprises storing the lower-resolution version of the stream of decrypted video content.

3. The method of claim 1, wherein:
processing the stream of decrypted video content comprises selecting a plurality of video frames in the stream of decrypted video data, wherein the selected video frames comprise less than all of the stream of decrypted video content; and
storing the representative data comprises storing the selected video frames from the stream of decrypted video content.

4. The method of claim 3, wherein:
the selected video frames comprise every Nth frame of the stream of decrypted video content, wherein N is greater than 1.

5. The method of claim 1, wherein:
processing the stream of decrypted video content comprises selecting a predetermined portion of each video frame in the stream of decrypted video content, wherein the predetermined portion of each video frame comprises less than all of each video frame in the stream of decrypted video content; and
storing the representative data comprises storing the selected portion of each video frame from the stream of decrypted video content.

6. The method of claim 1, wherein:
processing the stream of decrypted video content comprises determining a statistical value of each video frame in the stream of decrypted video content; and
storing the representative data comprises storing the statistical value of each video frame of the stream of decrypted video content.

7. The method of claim 6, wherein:
the statistical value of each video frame comprises at least one of a pixel histogram of a luminance channel of the video frame, a pixel histogram of a chrominance channel of the video frame, an average pixel value of a luminance channel of the video frame, an average pixel value of a chrominance channel of the video frame, a pixel value range of a luminance channel of the video frame, and a pixel value range of a chrominance channel of the video frame.

8. The method of claim 1, wherein:
processing the stream of decrypted video content comprises determining a number of pixels of each video frame in the stream of decrypted video content that match a statistical criterion; and
storing the representative data comprises storing the number of pixels of each video frame of the stream of decrypted video content that match the statistical criterion.

9. The method of claim 1, wherein:
processing the stream of decrypted video content comprises processing each video frame in the stream of decrypted video content to determine if the video frame matches a statistical criterion; and
storing the representative data comprises storing each video frame of the stream of decrypted video content that matches the statistical criterion.

10. The method of claim 9, wherein:
storing the representative data comprises storing a predetermined number of video frames after each video frame of the stream of decrypted video content that matches the statistical criterion.

11. The method of claim 1, wherein:
processing the stream of decrypted video content comprises processing metadata associated with the stream of decrypted video content to determine if the metadata matches a predetermined value; and
storing the representative data comprises storing at least a portion of at least one video frame of the stream of decrypted video content in response to the metadata matching the predetermined value.

12. The method of claim 1, wherein:
processing the stream of decrypted video content comprises processing each video frame in the stream of decrypted video content to determine if the video frame matches a statistical criterion; and
storing the representative data comprises storing at least one of a video frame number and a video frame timestamp for each video frame of the stream of decrypted video content that matches the statistical criterion.

13. The method of claim 1, wherein:
processing the stream of decrypted video content comprises processing each video frame of the stream of decrypted video content to determine if a statistical value of the video frame deviates from a statistical value of another video frame; and
storing the representative data comprises storing at least one of the video frame, a video frame number for the video frame, and a timestamp for the video frame if the statistical value of the video frame deviates from the statistical value of the other video frame.

14. The method of claim 13, wherein:
the other video frame comprises a previous video frame of the stream of decrypted video content.

15. The method of claim 13, wherein:
the other video frame comprises a sample video frame not originating from the stream of decrypted video content.

16. The method of claim 13, wherein:
the statistical value comprises one of an average luminance value of the video frame and an average chrominance value of the video frame.

17. An electronic device, comprising:
an input interface configured to receive encrypted video content, wherein the encrypted video content comprises original video content that is encrypted according to a copy protection scheme;
decryption circuitry configured to decrypt the received encrypted video content to generate the original video content, wherein storage of the original video content in the electronic device is restricted under a license required to decrypt the received encrypted video content;
control circuitry configured to process the original video content to generate data representing at least one characteristic of the original video content, wherein storage of the data is not restricted under the license; and
data storage configured to store the data.

18. The electronic device of claim 17, further comprising:
a user interface configured to receive a selection of the at least one characteristic of the original video content;
wherein the control circuitry is configured to determine if the selection of the at least one characteristic results in the data being generated that may be stored in the data storage without violating the license.

19. A method of processing decrypted video content for subsequent analysis, the method comprising:
receiving encrypted video content generated by encrypting a stream of original video frames according to a copy protection scheme;
decrypting the encrypted video content to yield the stream of original video frames, wherein storage of the stream of original video frames is restricted under a license required to decrypt the encrypted video content;
processing the stream of original video frames to generate data representative of the stream of original video frames, wherein the representative data comprises at least one of statistical data describing at least one of the original video frames, identification information identifying at least one of the original video frames, and at least a portion of the video data of at least one of the original video frames, wherein storage of the representative data is allowed under the license; and
storing the representative data for subsequent analysis.

20. The method of claim 19, wherein:
the statistical data comprises at least one of luminance information and chrominance information of the at least one of the original video frames.
